(19) United States
(12) Patent Application Publication
(10) Pub. No.: US 2012/0090159 A1
(43) Pub. Date: Apr. 19, 2012

(54) Method For The Installation And Removal Of A Conveyor Belt

(76) Inventor: André Hahn, Buizingen (BE)

(21) Appl. No.: 12/907,338

(22) Filed: Oct. 19, 2010

(51) Int. Cl. B23P 11/00

(52) U.S. Cl. 29/525.15

(57) ABSTRACT

The invention relates to a method for the installation and removal of a conveyor belt (5) on drive rollers (1) by means of an endless supporting belt (2) stretched over said rollers, wherein said conveyor belt has an outer surface, an inner surface, and two free ends.

The invention is characterized in that:
a) for the installation of a conveyor belt that includes a substrate sheet (6), one surface of which includes a polyurethane coating bearing a printed image, which coating is covered by a mixture of materials that protect this image, a portion (15, 15a) of the conveyor belt is defined at each of its two transverse ends (14, 14a) only, and then, with the conveyor belt being positioned longitudinally and stretched over said supporting belt, and with said two transverse ends being juxtaposed, said two portions of the conveyor belt are joined together by being secured or not to the supporting belt;
b) for removal, the portions of the conveyor belt are separated and the conveyor belt is removed.

The present invention relates generally to a method for the installation and removal of a conveyor belt on drive rollers.

In particular, the invention relates to a method for the installation and removal of a conveyor belt on drive rollers by means of an endless supporting belt stretched over said drive rollers, specifically a conveyor belt for a checkstand counter, so as to ensure the transit of said conveyor belt which has an outer surface, an inner surface, and two free transverse ends.

The installation of a conveyor belt in a checkstand counter, e.g. a checkstand counter in a supermarket or in any other type of store, usually requires various manipulations including, in particular, the opening of the counter and the removal of various accessories before free access can be gained to the rollers intended to support and drive the belt which must be installed and stretched over them. The entire set of operations required for this purpose, from the opening to the closing of the counter, usually requires 40 to 120 minutes. Because the working lifetime of a conveyor belt on a checkstand counter does not exceed 6 months of use, it is of primary importance to minimize the time required to remove a worn belt and to replace it with a new belt, so as to reduce the duration of the interruption in the use of the checkstand counter while also minimizing the corresponding inconveniences caused to employees.

To facilitate the installation of a conveyor belt on drive rollers so as to ensure its transit, that conveyor belt can be joined to a supporting belt itself applied on those rollers. Such a method has been described in patent application WO 2006/066087 for the installation, on drive rollers, of a conveyor belt made of a stretchable material with a printable surface for instance a fabric, that surface being covered, if necessary, with a transparent film of polyurethane. According to the method reported in said patent, the joint of the conveyor belt to the supporting belt is achieved through the application of a means of the Velcro® type applied on four portions of said supporting belt.

During the development of the present invention, trials have been undertaken for joining, to a supporting belt, a conveyor to belt of the type referred to above and used in the present invention i.e. a conveyor belt that includes a substrate sheet, one surface of which including a polyurethane coating bearing a printed image, which coating being itself covered by a mixture of materials that protect this image. To this end an adhesive material has been applied on the inner surface of the conveyor belt i.e. the surface that faces the drive rollers, so as to join this surface to the outer surface of a supporting belt i.e. the surface that do not face the drive rollers. It has been observed during these trials that the gluing of the entire inner surface of the conveyor belt on the supporting belt causes, during the transit of the two belts thus joined, stresses and stretching that lead to the deformation of the assembly when it passes over the drive rollers. An analogous phenomenon was also noted when various portions of the conveyor belt, distributed over its entire length, were joined to the supporting belt through gluing especially when are joined to the supporting belt four portions of the conveyor belt i.e. one portion defined at each of its two entire longitudinal ends and one portion at each of its two entire transverse ends as described in patent application WO 2006/066087 referred to above. This result shows that the method reported in that patent is not adapted to the conveyor belt used in the present invention.

The object of the present invention is to provide a method, of the type described hereinabove, that can mitigate the foregoing disadvantages in that it allows a conveyor belt to be installed and removed significantly more quickly than with the prior procedure and without the disadvantages of the prior art here above defined.

To achieve this object, the method according to the invention is characterized in that:

a) for the installation of a conveyor belt that includes a substrate sheet, one surface of which includes a polyurethane coating bearing a printed image, which coating is covered by a mixture of materials that protect this image, a portion of the conveyor belt is defined at each of its two transverse ends only, and then, with the conveyor belt being positioned longitudinally and stretched over said supporting belt, and with said two transverse ends being juxtaposed, said two portions of the conveyor belt are joined together by being secured or not to the supporting belt;

b) for removal, the portions of the conveyor belt are separated and the conveyor belt is removed.

According to another feature of the invention, the joint between the two portions of the conveyor belt is achieved through the application of an adhesive material, used alone or in association with a strip of material that has an inner surface and an outer surface.

For the purposes of the present invention, the term “inner surface” shall be understood as referring to a surface that faces the drive rollers, and the term “outer surface” shall be understood as referring to a surface that does not face the drive rollers, regardless of whether the surface in question belongs to the conveyor belt, the supporting belt or the strip of material, or constitutes a portion of any of them. Accordingly, the outer surface of the conveyor belt is defined by the coating consisting of a mixture of materials that protect the printed image.

The method according to the invention may be implemented in various ways, depending on whether the adhesive material is used alone or in association with a strip of material serving as a substrate for the adhesive material.

Thus, according to one embodiment of the present method, in which an adhesive material is used alone, the joint between the two portions of the conveyor belt is achieved through the application of this adhesive material to the inner surface of each of the two portions of the conveyor belt and/or to the outer surface of the supporting belt, so as to secure said two portions of the conveyor belt to the supporting belt.

However, according to an embodiment of the method according to the invention in which an adhesive material is used in association with a strip of material serving as a substrate for the adhesive material, the joint between the two portions of the conveyor belt is achieved through the application of this strip of material to the supporting belt and to the inner surface of each of these two portions of the conveyor belt, with this strip of material, which overlaps these two portions, having its inner surface and its outer surface covered with an adhesive material, so as to secure said two portions of the conveyor belt to the supporting belt.

So as to strengthen the joint between the two portions of the conveyor belt, a strip of material preferably a strip of transparent material can, if necessary, be applied on the outer surface of each of said portions of the conveyor belt, with this strip of material which overlaps these two portions, having its inner surface covered with an adhesive material.

Alternatively, according to another embodiment of the present method, the joint between the two portions of the conveyor belt is achieved through the application of a strip of material of which a first portion, which is covered with an adhesive material on its inner surface and on its outer surface, is located between the outer surface of the supporting belt and the inner surface of the conveyor belt, and of which a second portion, which is covered with an adhesive material on its inner surface, is located on the outer surface of the conveyor belt, so as to secure the first portion of the strip of material to the supporting belt and to the conveyor belt, and so as to secure the second portion of the strip of material to the conveyor belt.

These various embodiments require that the conveyor belt be secured to the supporting belt. However, the conveyor belt can be installed on the supporting belt without being secured thereto due to the fact that the two portions of the transverse ends defined on the conveyor belt are joined together independently of the supporting belt. During the transit of the conveyor belt driven by the supporting belt installed on rollers, it has been observed that the conveyor belt does not slide on the supporting belt, or else does so in a manner imperceptible to the human eye, without in any way compromising the proper course of the operation.

Consequently, according to another embodiment of the method according to the invention, the joint between the two portions of the conveyor belt is achieved through the application of a first strip of material to the inner surface of each of these portions of the conveyor belt, with this strip of material, which overlaps these two portions, having one of its surfaces covered with an adhesive material, and/or through the application of a second strip of material to the outer surface of each of these portions of the conveyor belt, with this strip of material, which overlaps these two portions, having one of its surfaces covered with an adhesive material, so as to secure to each other said two portions of the conveyor belt.

In this embodiment, the strip of material that covers the inner surface of each of these portions, and the strip of material that covers the outer surface of each of the same portions, may be either identical or different in size. When these sizes are different, it is generally preferable for the smaller strip of material to be applied to the outer surface of each of these portions of the conveyor belt.

Moreover, according to a further embodiment of the method according to the invention, the joint between the two portions of the conveyor belt is achieved through the application of a single strip of material to the inner surface and to the outer surface of each of these two portions, with this single strip of material, which overlaps these two portions, having one of its surfaces covered with an adhesive material, so as to secure to each other said two portions of the conveyor belt.

According to another feature of the invention, each of the portions defined on the conveyor belt is separated by being peeled off, specifically with the aid of heating.

The portions of the conveyor belt are advantageously secured to the supporting belt by means of a material that can lose its adhesive property when heated, so that, if necessary, the supporting belt can be separated from the conveyor belt in order to allow for the removal of the conveyor belt.

Furthermore, this adhesive material is chemically neutral towards the constituents of the supporting belt and of the conveyor belt with which it comes into contact.

The adhesive material in question is preferably selected from among glues that meet the foregoing criteria, or from among adhesive systems. The latter include, for example, a strip of material usually provided as a sheet of natural or synthetic material, such as a sheet of fabric or of plastic material, whose surfaces are covered with an adhesive material.

During the development of the present invention, it was observed that the gluing of the entire inner surface of the conveyor belt to the outer surface of the supporting belt causes, during the transit of the two belts thus joined, stresses and stretching that lead to the deformation of the assembly when it passes over the drive rollers. An analogous phenomenon was also noted when various portions of the conveyor belt, distributed over its entire length, were joined to the supporting belt through gluing.

However, within the scope of the present invention, it was demonstrated that these stretching and stress phenomena, as well as other deformations, do not occur if the conveyor belt is secured to the supporting belt, specifically through adhesion, only at a single surface area that does not exceed certain limits—in this instance, a single surface area whose length, as determined along the longitudinal axis of the belt, is at most 100 mm, while its width is equivalent to the width of the belt in question. Nevertheless, this single surface area may be distributed among multiple juxtaposed portions, e.g. two juxtaposed portions, each of which is no more than 50 mm in length. So as to maintain continuous and uniform contact between the conveyor belt and the supporting belt, each of these two juxtaposed portions constitutes a terminal portion of this belt. Accordingly, when the conveyor belt is installed and stretched over the supporting belt, with the two ends in juxtaposition, the two surface portions are equivalent to a single surface area.

Thus, according to another feature of the invention, the length of each of said portions to be secured is at most 50 mm, and preferably approximately 30 mm, with the width of these portions being equivalent to the width of the conveyor belt.

The supporting belt used for the purposes of the present invention typically includes an antistatic substrate sheet made of flexible material, e.g. a sheet of fabric or a sheet of woven felt, that can reduce the stretching phenomenon, or more generally, a sheet of material, such as certain polyesters, that possess a high degree of tensile strength as well as a high degree of dimensional stability or shape stability. This substrate sheet is usually covered by a layer of flexible material that defines the outer surface of the supporting belt. For example, it may consist of a natural or synthetic elastomer, such as natural or synthetic rubber, or a thermoplastic polymer material, such as polyvinyl chloride or polyurethane.

This supporting belt, whose ends are brought together in juxtaposition so as to form an endless belt, is installed on drive rollers and stretched over them. Securing is customarily achieved through any appropriate means, such as stapling or high-frequency heat-welding.

The conveyor belt likewise consists essentially of an antistatic substrate sheet made of a flexible material, such as a sheet of fabric or a sheet of woven felt, that can display a high degree of tensile strength, resist abrasion and aging, and also reduce the stretching phenomenon. This sheet typically has the same properties as the sheet used for the supporting belt, in that it possesses a high degree of tensile strength and a high degree of resistance to three-dimensional deformations. For example, it may consist of a sheet of antistatic fabric, antistatic woven felt, or polyester.

This sheet is covered by a layer of flexible material that defines the outer surface of the conveyor belt. This coating is obtained from a natural or synthetic elastomer, such as natural or synthetic rubber, or a thermoplastic polymer material, such as polyvinyl chloride or polyurethane. The latter material is particularly preferred when this coating is intended to receive printed images, as described in European patent application No. EP 1,788,544. In this case, the polyurethane intended to receive this printing is initially preferably white, which coloration typically results from dyes or pigments incorporated directly into the body of the material.

The polyurethane coating is commonly obtained through the application of a powdered polymer to the substrate sheet, followed by heating to liquefaction and then by uniform distribution over said sheet. However, this method has the disadvantage of producing a non-homogeneous polymer layer, because of the presence of residual air bubbles in the body of the material or of air bubbles that are introduced through the permeable substrate sheet. As a result, these bubbles cause weaknesses within this layer, which weaknesses are manifested as cracks that appear after the transit of the conveyor belt, and particularly after its passage over the drive rollers.

Nevertheless, within the scope of the present invention, it was demonstrated that the use of polyurethane in the form of a paste deposited on the substrate sheet of the conveyor belt, and then heated to fluidization and distributed uniformly over this substrate sheet, makes it possible to mitigate this disadvantage and thereby prolong the lifetime of the conveyor belt. After being manufactured, this belt has a perfectly flat visible outer surface that may be used as is or, preferably, may be covered with coloration zones that may combine written text and decorative or other graphic designs that may correspond, for example, to trademarks, slogans, promotional or non-promotional announcements, or any type of information intended for the general public.

These coloration zones are typically obtained by printing, in accordance with the method described in European patent application No. EP 1,977,982, whose stages can be summarized as follows:

a) degreasing of the conveyor belt in question, on the surface intended to receive the printing;

b) treatment, with an excimer laser, of said surface, so as to increase its surface energy;

c) creation of a digital image, e.g. an image associated with an advertisement, and storage of said image on an appropriate medium;

d) transmission of this digital image to a plotter or printer;

e) printing of the image on said surface, through the formation of at least one layer of ink obtained by spraying the ink from the plotter or printer;

f) drying of the ink used in the printing, via ultraviolet radiation or in the presence of oxygen, depending on the type of ink;

g) covering of said surface with at least one layer of a material, or a mixture of materials, intended to protect the printed image;

h) drying of the layer of protective material(s).

The invention will be readily understood, and other objects, characteristics and advantages thereof will appear more clearly from the following detailed description, with reference to the accompanying diagrammatic drawings, given only by way of non-limiting example and illustrating an embodiment of the invention, in which:

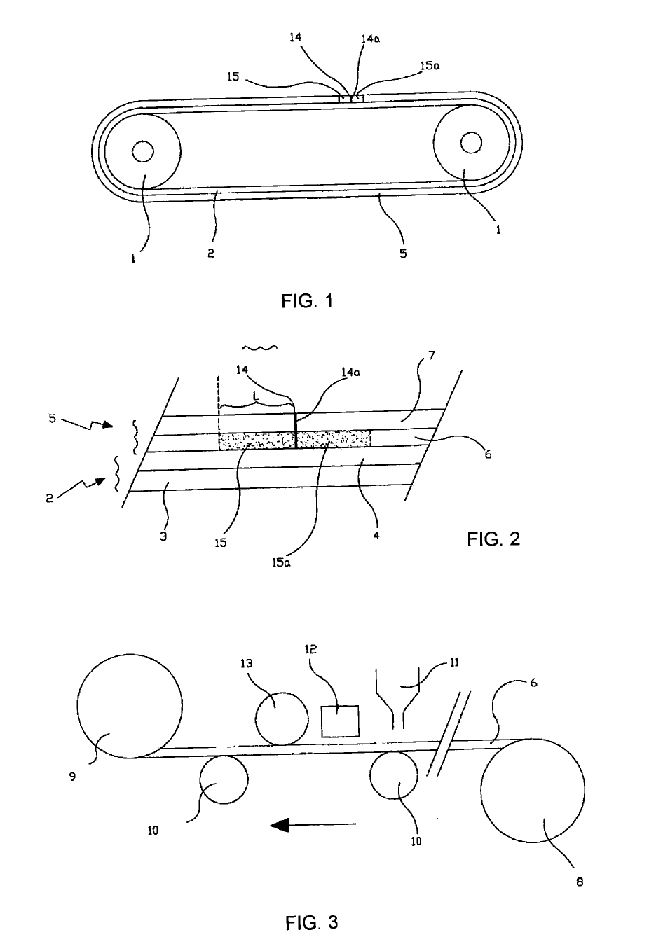

FIG. 1 is a schematic sectional view of a conveyor belt installed according to the invention, on drive rollers;

FIG. 2 is a schematic sectional view of a conveyor belt secured to a supporting belt;

FIG. 3 is a schematic view of the coating stage in the method for manufacturing a conveyor belt;

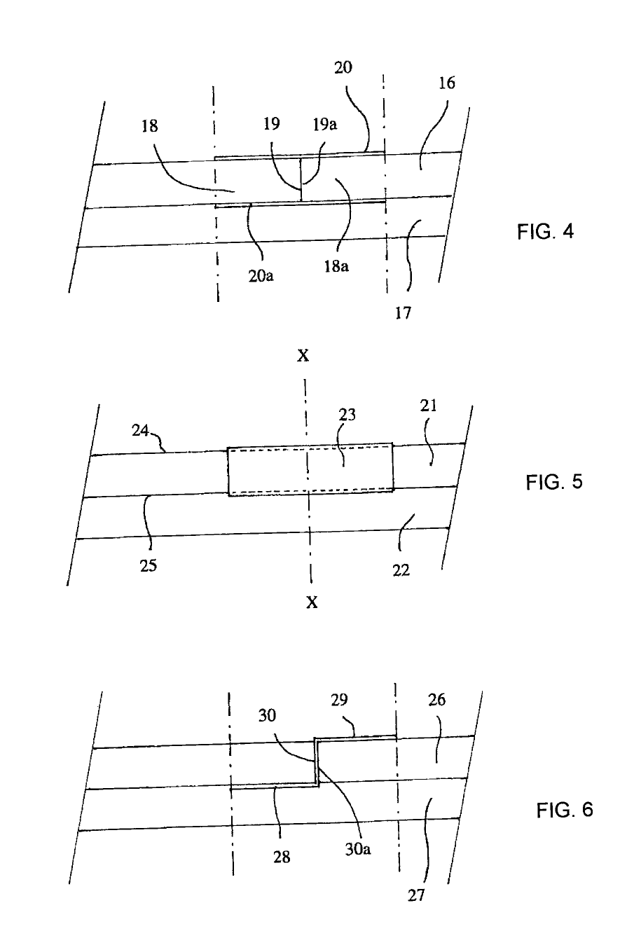

FIGS. 4 and 6 are schematic sectional views of other embodiments of the installation of a conveyor belt on a supporting belt; and

FIG. 5 is a front view of another embodiment of the installation of a conveyor belt on a supporting belt.

As shown in FIG. 1, rollers 1 that can rotate on their axes under the action of any drive device (not shown), such as a gear motor, support an endless supporting belt 2 that is installed and stretched over the rollers. As shown in FIG. 2, the latter belt consists of a substrate sheet 3, made of a technical fabric approximately 3,350 cm long, to which a polyvinyl chloride coating 4 is applied in a flat and uniform manner.

FIG. 1 also shows, installed over the entire the supporting belt, a conveyor belt 5 that consists, as shown in FIG. 2, of a substrate sheet 6 made of a technical fabric covered by a polyurethane coating 7 distributed in a flat and uniform manner and bearing printed images (not shown).

As shown in FIG. 3, this conveyor belt 5 may be manufactured from a substrate sheet 6 that is unrolled continuously from a feeder reel 8 to a take-up spool 9, after passing over one or more supporting rollers 10. During its course of travel, this substrate sheet receives, by means of an injector 11, a given quantity of polyurethane in the form of a paste whose body is tinted white. This paste, which is fluidized by any heating device 12, forms a polyurethane layer that is distributed uniformly by means of an equalizer roller 13 and then cooled in open air downstream of this roller.

The surface intended to form the visible surface of the conveyor belt 5 is then degreased in order to eliminate solid and/or liquid debris, in particular greasy residues resulting from the manufacture of the polyurethane coating. This layer then undergoes treatment with an excimer laser, with a view to increase its surface energy. After this operation, a previously created digital image is sent by computer to a plotter that prints said image by spraying jets of ink onto the treated surface. The layer of sprayed ink is dried, either under an oxygenated atmosphere or by ultraviolet radiation, depending on the nature of this ink.

After the conveyor belt has been cooled in a stream of air near or below room temperature, a layer of colorless protective varnish is applied to the ink layer and dried via ultraviolet radiation at approximately 110-120° C.

As can also be seen in FIGS. 1-2, the conveyor belt 5 has two juxtaposed ends 14, 14a, each of which defines one of the edges of two portions 15, 15a of the inner surface of the substrate sheet 6. These portions, each of which has a length L of approximately 30 mm, are secured by being glued to the outer surface of the coating 4 of the supporting belt 2.

According to one embodiment of the invention, this conveyor belt 5 can be installed on the assembly consisting of the supporting belt 2 and the rollers 1 by starting with a conveyor belt that is slightly longer than the supporting belt, i.e. on the order of 3,360 cm, and that has two free ends.

First, a layer of glue is applied to the entire width of the supporting belt 2 and to a length of approximately 60 mm. Similarly, the glue is then distributed over the entire width of the conveyor belt 5, firstly over a length of approximately 30 mm, equivalent to portion 15, and secondly over a length of approximately 80 mm, at the opposite terminal portion. This terminal portion contains the portion 15a whose length is approximately 30 mm. The terminal portion of this belt 5, which includes portion 15, is then placed longitudinally on the outer surface of the supporting belt 2, and portion 15 is then secured by being glued, over its entire width, to the supporting belt. The initial conveyor belt is then entirely applied to the supporting belt and any excess of the conveyor belt is cut and removed, such that the end 14 and the resulting end 14a are perfectly juxtaposed. The second portion, located at the end 14a, i.e. portion 15a, is then secured over its entire width, likewise by being glued to the supporting belt.

The conveyor belt installed in this way can be removed by heating the portions 15 and 15a, which leads to the separation of these portions and makes it possible to peel the conveyor belt completely away from the supporting belt.

According to another embodiment, as shown in FIG. 4, the conveyor belt 16 is placed on a supporting belt 17. This conveyor belt includes two portions 18, 18a, located on either side of two transverse ends 19, 19a. These two portions 18, 18a are covered respectively by strips of material 20, 20a that adhere to the conveyor belt, with the strip of material 20a not adhering to the supporting belt.

However, according to a preferred embodiment, the strip of material 20a adheres also to the supporting belt.

Furthermore, the embodiment shown in FIG. 5 shows a conveyor belt 21 and a belt 22 used as a support for the conveyor belt 21. This conveyor belt includes two ends (not shown) that are located on the X-X axis and that are overlapped by a single strip of adhesive material 23 that covers both a portion of the outer surface 24 and a portion of the inner surface 25 of this belt. However, this strip of material 23 does not adhere to the supporting belt.

Moreover, FIG. 6 shows an embodiment of the invention that includes a conveyor belt 26, a supporting belt 27, and a strip of adhesive material, a first portion 28 of which adheres both to the conveyor belt and to the supporting belt, with a second portion 29 adhering only to the conveyor belt. It should also be noted that this strip of material is insinuated between the juxtaposed transverse ends 30 and 30a of the conveyor belt.

The method according to the invention, as described herein, can be implemented within a minimal period of time that typically does not exceed 45 minutes. Furthermore, this method is extremely simple, because it involves the gluing of only an extremely small portion of the conveyor belt, and moreover, said gluing can easily be removed when the belt is removed.

1. A method for the installation and removal of a conveyor belt (5) on drive rollers (1) by means of an endless supporting belt (2) stretched over said drive rollers, specifically a conveyor belt for a checkstand counter, so as to ensure the transit of said conveyor belt which has an outer surface, an inner surface, and two free transverse ends, whereby:
a) for the installation of a conveyor belt that includes a substrate sheet (6), one surface of which includes a polyurethane coating bearing a printed image, which coating is covered by a mixture of materials that protect this image, a portion (15, 15a) of the conveyor belt is defined at each of its two transverse ends (14, 14a) only, and then, with the conveyor belt being positioned longitudinally and stretched over said supporting belt, and with said two transverse ends being juxtaposed, said two portions of the conveyor belt are joined together by being secured or not to the supporting belt;
b) for removal, the portions of the conveyor belt are separated and the conveyor belt is removed.

2. A method according to claim 1, whereby the joint between the two portions of the conveyor belt is achieved through the application of an adhesive material, used alone or in association with a strip of material that has an inner surface and an outer surface.

3. A method according to claim 1, whereby the joint between the two portions of the conveyor belt is achieved through the application of an adhesive material to the inner surface of each of the two portions of the conveyor belt and/or to the outer surface of the supporting belt, so as to secure said two portions of the conveyor belt to the supporting belt.

4. A method according to claim 1, whereby the joint between the two portions of the conveyor belt is achieved through the application of a strip of material to the supporting belt and to the inner surface of each of these two portions of the conveyor belt, with this strip of material, which overlaps these two portions, having its inner surface and its outer surface covered with an adhesive material, so as to secure said two portions of the conveyor belt to the supporting belt.

5. A method according to claim 1, whereby the joint between the two portions of the conveyor belt is achieved through the application of:
a strip of material to the supporting belt and to the inner surface of each of these two portions of the conveyor belt, with this strip of material, which overlaps these two portions, having its inner surface and its outer surface covered with an adhesive material, so as to secure said two portions of the conveyor belt to the supporting belt,
a strip of material on the outer surface of each of these two portions of the conveyor belt, with this strip of material, which overlaps said two portions, having its inner surface covered with an adhesive material.

6. A method according claim 1, whereby the joint between the two portions (18, 18a) of the conveyor belt (16) is achieved through the application of a first strip of material (20a) to the inner surface of each of these portions of the conveyor belt, with this first strip of material, which overlaps these two portions, having one of its surfaces covered with an adhesive material, and/or through the application of a second strip of material (20) to the outer surface of each of these portions of the conveyor belt, with this second strip of material, which overlaps these two portions, having one of its surfaces covered with an adhesive material, so as to secure to each other said two portions of the conveyor belt.

7. A method according to claim 1, whereby the joint between the two portions of the conveyor belt (21) is achieved through the application of a single strip of material (23) to the inner surface (25) and to the outer surface of each of these two portions, with this single strip of material, which overlaps these two portions, having one of its surfaces covered with an adhesive material, so as to secure to each other said two portions of the conveyor belt.

8. A method according to claim 1, whereby the joint between the two portions of the conveyor belt (26) is achieved through the application of a strip of material of which a first portion (28), which includes an adhesive material on its inner surface and on its outer surface, is located between the outer surface of the supporting belt and the inner surface of the conveyor belt, and of which a second portion (29), which includes an adhesive material on its inner surface, is located on the outer surface of the conveyor belt, so as to secure the first portion of the strip of material to the supporting belt and to the conveyor belt, and so as to secure the second portion of the strip of material to the conveyor belt.

9. A method according to claim 1, whereby the length of each of the portions to be secured is at most 50 mm, with the width of these portions being equivalent to the width of the conveyor belt.

10. A method according to claim 1, whereby the length of each of the portions to be secured is approximately 30 mm.

11. A method according to one of claim 1, whereby each of the portions is separated by being peeled off.

12. A method according to claim 1, whereby each of the portions is separated by being peeled off with the aid of heating.

13. A method according to claim 1, whereby the supporting belt includes, applied to a substrate sheet, a polyvinyl chloride coating that defines the outer surface of this supporting belt.

14. A method according to claim 1, whereby the polyurethane coating is obtained from polyurethane in the form of a paste deposited on the substrate sheet.

15. A method according to claim 1, whereby the substrate sheet (6) is a sheet of antistatic fabric, antistatic woven felt, or polyester.
